(19) United States
(12) Patent Application Publication
(10) Pub. No.: US 2019/0204183 A1
(43) Pub. Date: Jul. 4, 2019

(54) METHOD FOR ASSESSING THE STATE OF AN INTERNAL COMBUSTION ENGINE

(71) Applicant: AVL LIST GMBH, Graz (AT)

(72) Inventors: Rüdiger TEICHMANN, Hart B. Graz (AT); Martin ABART, Graz (AT)

(21) Appl. No.: 16/323,732

(22) PCT Filed: Aug. 9, 2017
(86) PCT No.: PCT/AT2017/060200

§ 371 Date: Feb. 6, 2019

(30) Foreign Application Priority Data
Aug. 9, 2016 (AT) A 50725/2016

(51) Int. Cl. G01M 15/08; F02D 35/02

(52) U.S. Cl. CPC G01M 15/08; F02D 41/0085; F02D 2400/08; F02D 35/023

(57) ABSTRACT

The invention relates to a method for assessing the state of an internal combustion engine with multiple cylinders with a first pressure sensor and a second pressure sensor connected to an evaluation unit, wherein in each case one cylinder pressure is measured using the pressure sensors. The first pressure sensor measures a reference measurement signal of a cylinder, assumed as a reference cylinder, of the internal combustion engine, and the second pressure sensor measures a first measurement signal of a first cylinder which differs from the reference cylinder, and in that the reference measurement signal of the reference cylinder and the first measurement signal are transmitted to the evaluation unit.

The invention relates to a method for assessing the state of an internal combustion engine with multiple cylinders with a first pressure sensor and a second pressure sensor connected to an evaluation unit, wherein in each case one cylinder pressure is measured using the pressure sensors.

There are two approaches to assessing the state of an internal combustion engine:

First, a single pressure sensor can be used to measure each cylinder over a specific period of time. In this case, only one pressure sensor is required. This makes the use of this method simple and inexpensive. However, due to load changes, there may be deviations between the measured pressure signals of the individual cylinders. This poses a problem for the evaluation, since these influences represent a non-negligible error for the evaluation of the state of the internal combustion engine.

On the other hand, methods are used to assess the state of an internal combustion engine which provide for one pressure sensor per cylinder. The cylinder pressures for all cylinders are measured simultaneously and it can thus be determined to what extent the individual cylinders differ from each other and which changes in the measurement signals can be traced back to load changes.

This method is known, for example, from DE 37 04 837 A1. In addition, it shows an initial compensation method for the measurement of cylinder pressures for internal combustion engines. It is provided in this case that each cylinder will have one piezoelectric pressure sensor each. A crank angle sensor is also provided to determine the position of the crankshaft. In one embodiment variant the pressure is corrected by a calculated fluctuation rate.

The disadvantage of this is that one pressure sensor must be provided per cylinder. This means that more pressure sensors are required depending on the number of cylinders. This makes the method costly and time-consuming. Also the evaluation of the measurement signals becomes more complicated for each additional cylinder.

It is the object of this invention to eliminate these disadvantages and to specify a method for assessing the state of an internal combustion engine which is simple and inexpensive to implement.

In accordance with the invention, this object is fulfilled by the method described in the introduction, in that the first pressure sensor measures a reference measurement signal of a cylinder of the internal combustion engine assumed to be a reference cylinder, and that the second pressure sensor measures a first measurement signal of a first cylinder which differs from the reference cylinder, and that the reference measurement signal of the reference cylinder and the first measurement signal are transmitted to the evaluation unit. Therefore, only one evaluation unit is necessary for carrying out the method, which always provides for the same number of sensors. The computing effort is therefore kept within limits and remains simple. In addition, only two pressure sensors are required.

It is advantageous if the first measurement signal of the first cylinder and the reference measurement signal of the reference cylinder are compared by the evaluation unit. This allows load changes to be compensated, for example. Subsequently, it is possible to pass on the results for diagnostic purposes and to calculate work or performance and to compare the results of one cylinder with each other.

A further application variant provides that, after measurement of the first measurement signal of the first cylinder with the second pressure sensor, at least one further measurement of at least one further cylinder which is different from the reference cylinder is carried out with the second pressure sensor, and that at least one further measurement signal determined thereby is transmitted to the evaluation unit, and that during this time the first pressure sensor transmits a reference measurement signal to the evaluation unit. Thus, the method can be applied to any number of cylinders or the entire internal combustion engine without increasing costs and effort.

The same advantage arises if at least one further measurement signal of at least one other cylinder different from the reference cylinder and the reference measurement signal of the reference cylinder are compared with each other by the evaluation unit.

It is particularly advantageous if differences between a measurement signal and the reference measurement signal which are determined by comparison due to a change in the operating state of the internal combustion engine are mathematically corrected by the evaluation unit. In other words, differences between a measurement signal and the reference measurement signal caused by a changing operating state of the internal combustion engine are mathematically corrected by the evaluation unit. Thus changing load states can be compensated, since all measured signals are influenced by load changes during the measuring process. In addition, a reading error by a user of the process can be avoided by a mathematical correction. The user could misjudge the load change of the internal combustion engine and attribute the differences between the individual measurement signals to the state, for example to wear, of the internal combustion engine. The changing operating state is detected, for example, by the evaluation unit or transmitted from an engine control unit to the evaluation unit.

In order to be able to carry out an exact analysis of the measurement signals, it is advantageous if the evaluation unit assigns the measurement signals of the first pressure sensor and the second pressure sensor to a crank angle of a crankshaft.

This is particularly easy to realize if a sensor determines the crank angle of the crankshaft during the measurements and passes it on to the evaluation unit.

In order to obtain an arrangement with as few sensors as possible, it is advantageous if the crank angle of the crankshaft is determined by the evaluation unit on the basis of the measurement signals of the first pressure sensor and the second pressure sensor.

The invention is explained in more detail using the non-restrictive figures, wherein:

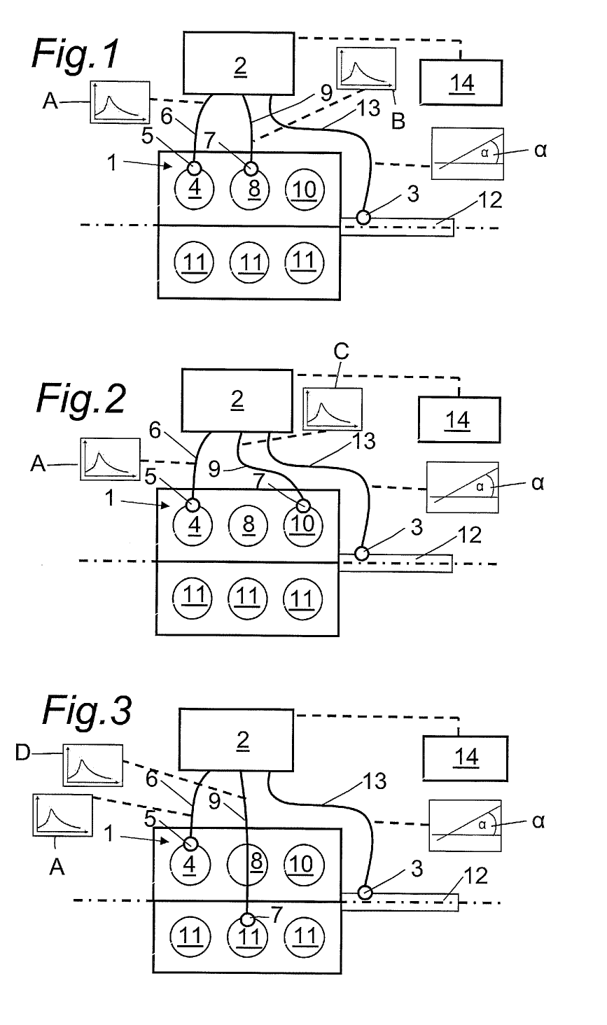

FIG. 1 shows a schematic representation of the application of a method according to the invention in a first step;

FIG. 2 shows a schematic representation of the application of the method in a second step; and

FIG. 3 shows a schematic representation of the application of the method in a further step.

To assess the state of an internal combustion engine 1 with several cylinders, an evaluation unit 2 with two pressure sensors and a sensor 3 for determining a crank angle α is provided. A cylinder is selected as reference cylinder 4 and a first pressure sensor 5 is attached. The first pressure sensor 5 measures a reference measurement signal A and transmits it to the evaluation unit 2 via a first line 6.

In a first step (FIG. 1), a second pressure sensor 7 measures a first measurement signal B of a first cylinder 8 different from the reference cylinder 4 and transmits it via a second line 9 to the evaluation unit 2.

Then, in a second step, as shown in FIG. 2, the second pressure sensor 7 is applied to a first additional cylinder 10. This measures a first additional measurement signal C. The second pressure sensor 7 transmits the first further measurement signal C to the evaluation unit 2. Simultaneously with the measurement of the second pressure sensor 7, the reference measurement signal A of the reference cylinder 4 is still transmitted to the evaluation unit 2.

As shown in FIG. 3, after this measurement the second pressure sensor 7 is attached to one of the remaining further cylinders 11 and the further measurement signals D are transmitted to the evaluation unit 2.

The evaluation unit 2 compares the measurement signal B, the first further measurement signal C and the further measurement signals D with the reference measurement signals A recorded at the same time. If, for example, large deviations from previous measurements occur during a load change, the course of the measurement signal B can be compensated for by comparing it with the course of the reference measurement signal A: The first further measurement signal C, for example, is mathematically corrected by the difference between a reference measurement signal A and a preceding reference measurement signal A. The same procedure is used for the other measurement signals D.

The sensor 3 for determining the crank angle α is used to assign the first measurement signal B, the first further measurement signal C, the further measurement signals D and the reference measurement signal A to a position of a crankshaft 12. The sensor 3 is connected to the evaluation unit 2 via a cable 13.

According to this scheme, the pressures of all cylinders of internal combustion engine 1 are measured over the crank angle α. By assigning the measurement signals A, B, C, D to a crank angle α, the comparison of the individual courses of the measurement signals A, B, C, D can be carried out more precisely by the evaluation unit 2. Thus it is possible to compare the respective measurement signal A, B, C, D for defined crank angles α and to consider the difference at exactly this point of the course as well as the difference.

In one embodiment, the provision of a sensor 3 for determining the crank angle α can be dispensed with, since the courses of the measurement signals can be used to assign these to a crank angle α by calculation.

The evaluation unit 2 evaluates the measurement signals A, B, C, D cylinder by cylinder and determines, for example, the indicated effective medium pressure or the maximum cylinder pressure for each cylinder. This is carried out by taking the reference measurement signal A into account. Deviations due to a changing operating state of the internal combustion engine 1 are detected from the reference measurement signal A and taken into account in the evaluation.

In addition to individual measurement courses from the measurement signals for each cylinder, evaluation unit 2 also determines averaged variables for the entire combustion engine 1.

Furthermore, the reference measurement signal A can serve as a time orientation, since the ignition sequence of the cylinders is known.

Based on the measurement signals A, B, C, D, the fuel supply for the individual cylinders, the reference cylinder 4, the first cylinder 8 and the other cylinders 10, 11 can be balanced via a control device 14. The work or power, or the indicated mean effective pressure, the maximum pressures, or the exhaust gas temperature of the individual cylinders can be considered. A control device 14 then has a compensating effect on the internal combustion engine 1 on the basis of the measurement signals A, B, C, D. This control unit 14 can, for example, be connected to the evaluation unit 2 via a radio link shown with the dashed line, or the input into the control unit 14 can be made manually by a user.

1. A method for assessing the state of an internal combustion engine having a plurality of cylinders with a first pressure sensor and a second pressure sensor, which are connected to an evaluation unit, the method comprising:
measuring a cylinder pressure of the plurality of cylinders with the first and second pressure sensors, characterized in that the first pressure sensor measures a reference measurement signal of a reference cylinder of the internal combustion engine and the second pressure sensor measures a first measurement signal of a first cylinder which is different from the reference cylinder; and
transmitting the reference measurement signal of the reference cylinder and the first measurement signal to the evaluation unit.

2. The method according to claim 1, further including comparing the first measurement signal of the first cylinder and the reference measurement signal of the reference cylinder by the evaluation unit.

3. The method according to claim 1, further including
after measurement of the first measurement signal of the first cylinder with the second pressure sensor, measuring at least one further measurement of at least one further cylinder which is different from the reference cylinder is carried out, and
simultaneously transmitting that at least one further measurement signal and the reference measurement signal to the evaluation unit.

4. The method according to claim 3, further including comparing the at least one further measurement signal of the at least one further cylinder and the reference measurement signal of the reference cylinder by the evaluation unit.

5. The method according to claim 1, further including mathematically correcting for, via the evaluation unit, the differences between the first measurement signal and the reference measurement signal on the basis of a changing operating state of the internal combustion engine.

6. The method according to claim 1, further including assigning, via the evaluation unit, the measurement signals of the first pressure sensor and of the second pressure sensor to a crank angle of a crankshaft.

7. The method according to claim 6, further including, during the measurements of the first and second pressure sensors, a sensor determines the crank angle of the crankshaft and transmits said angle to the evaluation unit.

8. The method according to claim 6, further including determining the crank angle of the crankshaft, via the evaluation unit, on the basis of the measurement signals of the first pressure sensor and of the second pressure sensor.

9. The method according to claim 2, further including
after measurement of the first measurement signal of the first cylinder with the second pressure sensor, measuring at least one further measurement of at least one further cylinder which is different from the reference cylinder is carried out, and
simultaneously transmitting that at least one further measurement signal and the reference measurement signal to the evaluation unit.

10. The method according to claim 4, further including mathematically correcting for, via the evaluation unit, the differences between the first measurement signal and the reference measurement signal on the basis of a changing operating state of the internal combustion engine.

11. The method according to claim 5, further including assigning, via the evaluation unit, the measurement signals of the first pressure sensor and of the second pressure sensor to a crank angle of a crankshaft.

12. The method according to claim 11, further including, during the measurements of the first and second pressure sensors, a sensor determines the crank angle of the crankshaft and transmits said angle to the evaluation unit.

13. The method according to claim 11, further including determining the crank angle of the crankshaft, via the evaluation unit, on the basis of the measurement signals of the first pressure sensor and of the second pressure sensor.
